(19) United States
(12) Patent Application Publication
(10) Pub. No.: US 2024/0044642 A1
(43) Pub. Date: Feb. 8, 2024

(54) Orbital Goniometer Autocollimation Device

(71) Applicant: Oren Aharon, Haifa (IL)

(72) Inventor: Oren Aharon, Haifa (IL)

(21) Appl. No.: 17/879,891

(22) Filed: Aug. 3, 2022

(51) Int. Cl. G01B 11/26

(52) U.S. Cl. CPC G01B 11/26

(57) ABSTRACT

The present invention relates to an apparatus and method for accurately measure angular deviation of rotating or stationary prismatic elements. The device is based on transferring the accuracy of an external rotating device to the to-be-measured device by building an orbital accuracy transfer system. In order to achieve the required rotational accuracy transfer, the measuring device is positioned on the perimeter of a rotating stage mounted around the to-be-measured part. As a part of the design and disclosed technology, an automation capability measurement will be integrated into the proposed system. Applicable measurements could be performed for satellites, prismatic elements, rotating stages, and many more. The system may comprise an accurately rotating stage or autocollimation theodolite, a reference rotating mirror, an optical bench, and a revolving mechanism for said electronic autocollimation theodolite. For system control, a computer with a special algorithm will be implemented.

### BACKGROUND OF THE INVENTION

### I. Field of Invention

The invention relates to high accuracy optical angle measurements for applications such as: prism characterization, measurement of rotating stages, satellite structural straightness & angular accuracy, optical cubes, polygons and many others. Today, several automatic and semi-automatic goniometers are available, which integrate an electronic autocollimator with a software-supported accurate digital stage which by design guarantees measurements of its angle of rotation by a very accurate angle encoder. The current technology is very expensive, cumbersome and requires highly trained personnel. For optimized measurements of various applications, the part should be placed on top of said rotation stage, and its angular facets are measured by the autocollimator as the specimen is rotated by the stage. The angle of rotation is transmitted to a computer for further processing. In industrial applications it is not always feasible to place the specimen under test on the rotating table due to its size, weight or being a part of a larger system. It is the purpose of this invention to offer a measuring goniometer which will perform the necessary tasks by an orbital movement around the specimen. This invention will offer a solution which is free of current art drawbacks.

A special application is the satellite world which requires very accurate installation and position of some instruments. To ensure the installation position and accuracy meet the design requirement, there is a need to perform and characterize the inter-relationship between satellite sensors. An efficient angle measurement, preferable automatic, is required to verify the said installation.

### 2. Description of the Related Art

Prior art technology relates to a goniometric device, conceived to measure a planar surface of optical prism or polygons. Said goniometric device comprises of a rotating stage with built-in holders for an exemplar, measuring unit is based on an autocollimator device and a rotating stage. In order to measure relative angular directions of various surfaces on the prism, the said stage is rotated to a degree when another surface of the prism is perpendicular to the autocollimator device. The angle of rotation is preferable measured by an accurate encoder. Since the encoder monitors the angular rotation in absolute values, the two measured planes will represent exactly the angular value in between. Then, the angle of rotation is clearly determined by said encoder. Seldom, accurate angular measurements are required in various applications such as satellites, antenna mounting, rotation of slewing tables, and many more. In those applications, it is very difficult if not impossible, to mount the device on a rotating stage for performing the necessary analysis. It is the purpose of disclosed art to offer a solution wherein the object under measurement is stationary and an orbital system will measure the relative angular attitude in both pan & tilt directions with very high accuracy.

### SUMMARY

The present invention provides a method and system to perform angular attitude measurements of optical or other reflective objects. The system will perform accurate measurements over an angle of 360 degrees in the pan direction and about a maximum of +/−80 degrees in tilt direction. Current technologies involve measurements based on rotating the specimen under examination on an accurate rotating stage equipped with a high-accuracy encoder. In the present invention it's not necessary to rotate the object, rather a specially developed electronic autocollimator theodolite mounted on a rotating member is orbitally moved around the specimen and measurements are made. Said measurements are generated by an angle transfer mirror, transferring rotation angle to a theodolite measuring device. The transformation relation between the reference mirror and theodolite is achieved by said mirror with a rectangular shape, wherein the mirror is longer than the path created by its movement in the panning direction. The disclosed technology offers a new method of angular measurements by mounting the examined specimen on a stationary stage equipped with a rotating mirror used for angular transfer and performing several stages as follows:
Initially the digital autocollimator theodolite is zeroed with the zero position of reference mirror.
Secondly, the mirror is rotated to a predeterminate rotational position by a non-accurate device such as low accuracy motor.
Thirdly, the theodolite is adjusted to read the new position of said mirror, performed on one end of this reflecting mirror.
Then, the theodolite is rotated until its aperture is aligned to the second end of reflecting mirror and using the autocollimator principle an accurate measurement of this new mirror position is generated by the theodolite built-in pan/tilt measuring capability.
At this stage the mirror is further rotated to a second position and the theodolite will measure the angle of this new position similarly to the procedure of angle measurement previously described.
By repeating this step consequently, one can measure the angular movement of the transfer mirror with very high accuracy provided by the built-in angular measurement capability of said digital collimation theodolite.
At each stage, the reference mirror position can be used to define the angle of a stationary specimen which by definition has reflective surfaces to be measured.
This final measurement is achieved by sharing input aperture of said autocollimator in such a way that the two reflective surfaces are presented to the autocollimator.
The analysis is performed by disclosed orbital goniometric autocollimator device, that is capable of intricate angular alignment measurement of various optical or other rotating devices to perform a new breed of measurements. The specimen under examination is stationary and its angular data is achieved by using a transfer mirror and the built-in capability of a theodolite to perform accurate angular measurements.
The key technology is based on implementing a versatile device for angle measurements used in a wide range of applications in surveying civil engineering, combined with modern electronic autocollimator featuring built-in measuring angular displacement in two axes of reflected light from mirrors.
The autocollimator's objective aperture will present the reflected light to a built-in imaging device and will reconstruct a light cross that originally was projected by the same autocollimator.
By analyzing the position deviation of reflected cross or crosses, the system presents the angular deviation of said reflected information.

To summarize, an apparatus or method for determining angular values of reflecting surfaces is disclose, comprising an orbital rotating stage including a hollow slewing bearing encompassing a stationary mount with a mounted electronic autocollimator theodolite, an autocollimator electronic theodolite mounted on the perimeter of said orbital rotating stage, at least one rotating reference mirror having the same axis of rotation as said orbital rotating stage, a stationary specimen to be measured mounted on said stationary mount, a control unit configured for reading the results of the electronic theodolite and said autocollimator to calculate the rotation angle and the reflected beam position from measured specimen, and an algorithm for calculating the rotational values according to sequential reading from theodolite angular results to reconstruct the total movement of the orbital rotating stage. In another embodiment, the aperture is wide enough to get reflection from both specimen and reference mirror. In yet another embodiment the said orbital rotating stage is motorized. In yet another embodiment, the theodolite is a total station theodolite with built-in motors. Special application is directed to determining angular values of sensors using the disclosed technology for satellites and optical pods.

The disclosed art represents a new technology and method of performing pan & tilt measurement of stationary devices, primarily optical elements, with high accuracy by angular transfer to a precise autocollimation theodolite.

### BRIEF DESCRIPTION OF THE DRAWINGS

FIG. 1 is a schematic illustration of prior art prism measuring device.

FIG. 2 is a schematic illustration of proposed theodolite with built-in electronic autocollimator having a large aperture and a significant field of view.

FIG. 3 is a schematic technical disclosure of proposed art.

FIG. 4 is illustrating the angular measuring transfer procedure in a step-by-step sequential illustration.

FIG. 5 is yet another illustration of orbital goniometric measuring device performing an inter-alignment and measurement of a satellite sensor.

### DETAILED DESCRIPTION OF THE DRAWINGS

Optical angle metrology is a valuable tool for measuring prismatic elements angles, polygons and inter-orientation of sensors mounted on an observation pod such as satellites, or aerial multi-sensor pods. Precise angle measurement devices are used in various applications where high precision is a must. An outstanding instrument for accurate measurement is the theodolite which can measure pitch and yaw relative to the earth's gravity down to 0.5 arcsec with less than 0.1 arcsec resolution. This instrument is mass produced and has an attractive price relative to its capability. Although from time to time it's used for optical measurement, it is not an adequate instrument to satisfy the measurement requirement for prismatic elements and inter-orientation for satellites and pods. The following figures will disclose an art and method for angular transfer capability to perform required measurements based on the high accuracy of a theodolite, more accurately an Autocollimator theodolite. The disclosed art is applicable to most of existing theodolites including optical theodolites, total station theodolites and robotic total station theodolites. This technology will also enable measurement of rotating tables and calibration of angle encoders. In precision engineering, ultra-performance is always a requirement, and the disclosed figures are only for demonstrative purposes, however the disclosed technology will not be restricted by this specific layout.

Further industrial applications for angular measurements could be found in such industries such as aircrafts, robotics, automobiles, and many more. The disclosed art is a traceable technology since it relies on a gold standard for angular measurements, in our case the theodolite.

Fusing technologies combining the electronic autocollimator with the theodolite telescope, yields a very effective tool since it can measure accurately the reflection from reflective surfaces with very high accuracy.

Examples of embodiments are illustrated by the accompanied drawings. Said drawings will be described, including specific details to facilitate the understanding of embodiments. However, it is apparent to one of ordinary skill in the art, the various descriptions could be implemented without the specific details. The used terminology for specific embodiments is used for better understanding and is not intended to limit the described art.

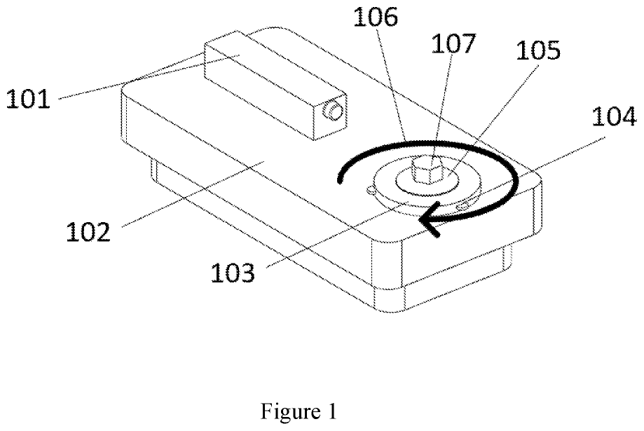

Reference of prior art technology will be made in respect with FIG. 1, wherein the present disclosure will be made to embodiment examples which their illustrations will follow.

FIG. 1 describes by a schematic way for measuring a prismatic element with current technology. An Autocollimator denoted as 101 projects an illuminated cross reticle towards to-be-measured exemplar, in this case polygon, one of its surfaces back reflects the outgoing projected cross to be recollected by same Autocollimator 101. The angular measurement of first surface is then recorded. A granite table denoted as 102 is the basis of Autocollimator and holding table 103 for the exemplar to lay upon. This table can be leveled to very high accuracy by using the adjustment screws 104. A bearing, preferable air-bearing equipped with a built-in angular encoder and denotes as 105 will allow rotation of the specimen to the next facet to be measured. The amount of rotation to said next facet is the angular difference between this specific facet and its value is given by the angular encoder. The rotation direction is given by 106 and the specimen 107 is rotated again to the next facet. This procedure is repeated until all facets are measured.

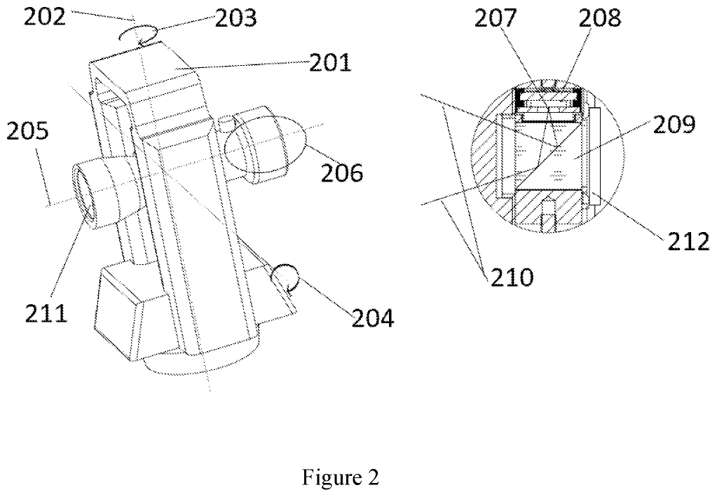

FIG. 2 describes a typical surveying theodolite equipped with an autocollimator eyepiece, transforming into an electronic autocollimator theodolite. The theodolite body is denoted by 201 and has a built-in horizontal panning axis denoted by 202 and a panning direction is denoted by 203. The elevation axis of theodolite is denoted by 204 and the telescope's axis is denoted by 205. The autocollimation eyepiece layout is magnified and its location on the theodolite is denoted as 206. In the right-hand side of FIG. 2, the magnified autocollimator eyepiece is disclosed, where the cross-reticle denoted by 207 is illuminated and projected by a light source 208 towards a Beamsplitter 209, further directed towards the objective lens. The beam cone is denoted as 210 and the objective lens is denoted as 211. The back reflected beam is recollected by same objective lens and focused on an imaging device. For measurement purposes, this device can project a cross towards an imaging device to be measured, or capture the reflection from a mirror to be measured.

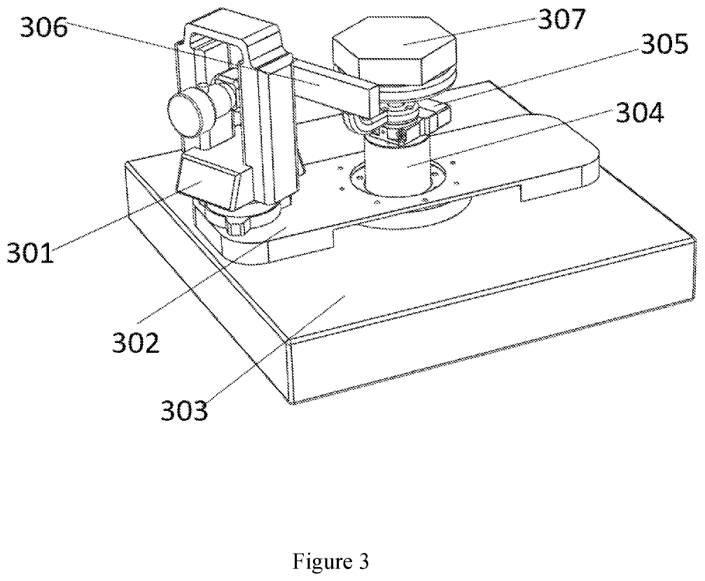

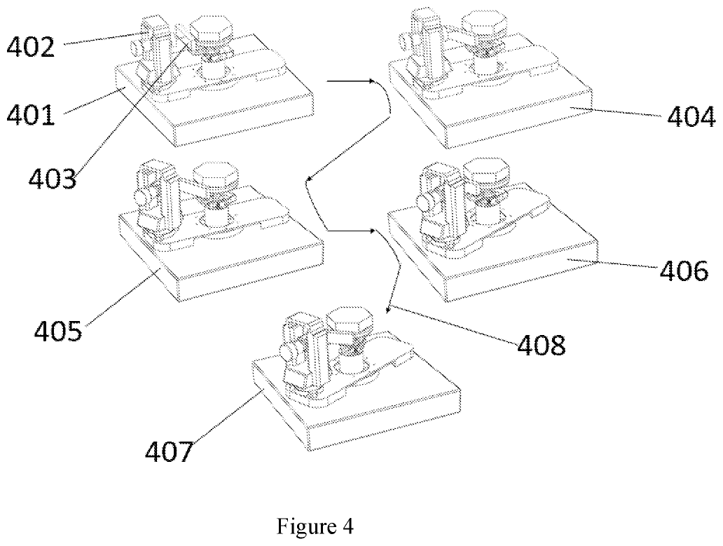

FIG. 3 is the layout of the proposed art where there is a transfer between the mirror rotation and the theodolite measurement. The theodolite and the mirror are orbiting around the device to be measured. The theodolite 301 is mounted on a rotating table 302 which lies upon the system carrying table 303. Said 302 is concentric to the device to be measured, which is stationary. The device to be measured 307 lays upon said 303 through a dedicated stationary pillar 304. A motorized table 305 has an orifice in its middle is connected to pillar 304 and its rotating part will rotate the mirror 306. This is the basic layout for measuring the angular facets of polygon exemplar, for better understanding we created a sequential measuring format disclosed in FIG. 4.

FIG. 4 is a step-by-step modeling of the angular transfer procedure, and it starts with the disclosed device in FIG. 3, it its initial position, and it's denoted as 401. The theodolite autocollimator denoted as 402 is initially aligned to be exactly perpendicular to the mirror 403. Then, the device changes the mirror position by rotating said motorized stage 305. Next step the said theodolite autocollimator is re-aligned to the mirror in its new position, and it shows in image 405, this re-alignment will be performed by rotating the Autocollimator theodolite from its initial position to be perpendicular to the mirror in its new position. In a sequential way, the theodolite is rotated around said pillar image 406 where it's re-aligned to the mirror, and then image 407 will restart the next stage and sequentially the angle could be measured around the stationary device.

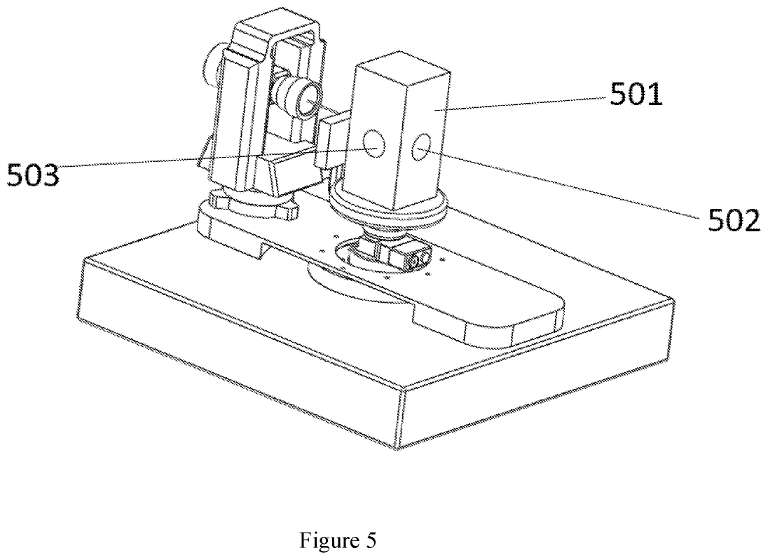

FIG. 5 describes yet another application for measuring sensor directions mounted on a satellite frame. The satellite 501 typically has multiple sensors which need to be aligned in between. By way of example, two typical sensors 502 & 503 are laid out in two different satellite walls. By using the disclosed sequential procedure in FIG. 4, one can perform similar measurements for this application.

What is claimed is:

1. An apparatus for determining angular values of reflecting surfaces comprising:
an orbital rotating stage including a hollow slewing bearing encompassing a stationary mount with a mounted electronic autocollimator theodolite;
an autocollimator electronic theodolite mounted on the perimeter of said orbital rotating stage;
at least one rotating reference mirror having the same axis of rotation as said orbital rotating stage;
a stationary specimen to be measured mounted on said stationary mount;
a control unit configured for reading the results of the electronic theodolite and said autocollimator to calculate the rotation angle and the reflected beam position from measured specimen; and
an algorithm for calculating the rotational values according to sequential reading from theodolite angular results to reconstruct the total movement of the orbital rotating stage.

2. An apparatus for determining angular values of reflecting surfaces according to claim 1, wherein the aperture of the collimator is wide enough to get reflection from both specimen and reference mirror.

3. An apparatus for determining angular values of reflecting surfaces according to claim 1, wherein the said orbital rotating stage is motorized.

4. An apparatus for determining angular values of reflecting surfaces according to claim 1, wherein the theodolite is a total station theodolite with built-in motors.

5. An apparatus for determining angular values of sensors according to claim 1, and mounted on satellites or optical pods.

6. A method for determining angular values of reflecting surfaces comprising:
an orbital rotating stage including a hollow slewing bearing encompassing a stationary mount with a mounted electronic autocollimator theodolite;
an autocollimator electronic theodolite mounted on the perimeter of said orbital rotating stage;
at least one rotating reference mirror having the same axis of rotation as said orbital rotating stage;
a stationary specimen to be measured mounted on said stationary mount;
a control unit configured for reading the results of the electronic theodolite and said autocollimator to calculate the rotation angle and the reflected beam position from measured specimen; and
an algorithm for calculating the rotational values according to sequential reading from theodolite angular results to reconstruct the total movement of the orbital rotating stage.
